(19) United States
(12) Patent Application Publication
(10) Pub. No.: US 2011/0159149 A1
(43) Pub. Date: Jun. 30, 2011

(54) PERFORMANCE OF COMPANION ANIMAL PALATABILITY SYSTEMS LEADING TO INCREASED PET FOOD CONSUMPTION PREFERENCES

(76) Inventors: David B. JOSEPHSON, Lebanon, OH (US); Alex U. Kamerer, Liberty Township, OH (US); Daniel L. Gallagher, Silverton, OR (US)

(21) Appl. No.: 12/648,711

(22) Filed: Dec. 29, 2009

(51) Int. Cl. A23K 1/18; A23K 1/00; A23K 1/16

(52) U.S. Cl. 426/62; 426/534; 426/302

(57) ABSTRACT

The invention concerns a palatability enhancing composition comprising at least one palatant and/or at least one tasteant modified by glycerol and/or propylene glycol. Said palatability enhancing composition is intended to be applied onto the surface of a companion animal food. The invention also extends to companion pet foods which are prepared with such palatability enhancing composition.

### FIELD OF THE INVENTION

The present invention relates to palatability enhancers, methods of enhancing the palatability of a companion animal food, in particular for cats and dogs, and methods of preparing a companion animal food.

### BACKGROUND OF THE INVENTION

Companion animals, in particular cats, may be finicky eaters. Accordingly, pet food manufacturers continually seek methods of producing companion animal foods with high degrees of palatability. A lot of approaches have been proposed for this purpose, including the development of palatability enhancers, such as palatants and tasteants.

The term palatant is defined as a flavor additive that invokes the senses of taste and/or smell, when the term tasteant is defined as a flavor additive that invokes the sense of taste. A large number of palatants and tasteants have been described so far. Some are intended to be admixed to companion pet foods. Others are intended to coat their surface (see for example U.S. Pat. No. 6,379,727, U.S. Pat. No. 6,254,920 and U.S. Pat. No. 6,350,485).

As palatants of the state of the art, the following examples can be cited: proteins, protein hydrolysates, biological extracts, dried yeast, yeast extracts, peptones, spices . . . . And as tasteants, the following examples can be cited: salts (as sodium chloride, potassium chloride, monosodium glutamate . . . ), glycine, alanine, nucleotides, savory powders (such as garlic, black pepper and onion) proteins, protein hydrolysates, pyrophosphates . . . .

Although the large number of already known palatants and tasteants, pet food manufacturers still develop new palatants and tasteants.

The purpose of the present invention is not to develop wholly new palatants and tasteants, but rather to propose a better use of already known palatants and tasteants, for improved results. Another purpose of the invention is to propose improved palatability enhancing compositions and also companion animal foods of high palatability.

### SUMMARY OF THE INVENTION

The previous mentioned objects and others may be attained by a palatability enhancing composition comprising at least one palatant and/or at least one tasteant modified/treated by glycerol and/or propylene glycol. The compositions according to the invention revealed to be particularly effective for enhancing the palatability of dry and semi-dry pet foods, compared to unmodified palatants and tasteants.

The invention also extends to companion pet foods, particularly intended to cats or dogs, which are prepared with palatability enhancing compositions according to the invention, i.e. pet food compositions the surface of which is coated, at least partially, with a palatability enhancing composition comprising at least one palatant and/or at least one tasteant modified/treated by glycerol and/or propylene glycol.

### DETAILED DESCRIPTION

According to the main object of the invention, there is provided a palatability enhancing composition comprising at least one palatant and/or at least one tasteant modified/treated by glycerol and or propylene glycol. The said composition is intended to be applied on a surface of a companion animal food.

The inventors have shown that pet foods having their surface coated with modified palatants or tasteants according to the invention have a palatability remarkably improved, as compared to their counterparts coated with unmodified palatants and tasteants.

It is believed that modification of palatants and tasteants with glycerol and/or propylene glycol lowers the surface free energy, and thus increases the wettability of palatants and tasteants. The increased wettability permits the taste receptors (i.e., taste buds) of a subject (e.g., cat, dog etc.) to sense the modified palatant and/or tasteant faster and/or more effectively than the unmodified counterpart of the palatant and/or tasteant. In turn, the taste and smell receptors transmit information regarding the particular taste and/or smell faster to the brain of the subject. Consequently, the subject will be able to taste and/or smell the pre-wetted palatant and/or tasteant faster or more effectively, leading to increased palatability.

Accordingly, modified palatants and/or tasteants provide similar palatability results at lower application rates compared to their unmodified counterparts. Further, modified palatants and/or tasteants provide better palatability performance when used at the same rate as their unmodified counterparts.

The modified palatants and tasteants, which enter into the palatability enhancing compositions according to the invention, can be obtained by various ways. Coating processes are particular suitable (for example, spray tumbling, dip coating, extrusion coating, pulverization . . . ). In a preferred embodiment, the palatants and/or tasteants are in a solid form and at least a part of their surface is coated with a thin film of glycerol and/or propylene glycol by spray tumbling the glycerol and/or propylene onto the surface of the dry item (e.g., a powder) by mixing in a bowl or blender.

According to the invention, both glycerol and propylene glycol can be used to prepare a palatability enhancer composition for surface application on a companion animal food. However, when the palatability enhancer composition is intended for consumption by cats, one of ordinary skill in the art will prefer avoiding propylene glycol that he knows as being toxic for cats. Other companion animals, for example dogs, have not this kind of problem with propylene glycol.

According to a particularly preferred embodiment of the invention, the palatability enhancing composition comprises up to 15 wt % glycerol, and more preferably, from about 0.1 to about 6 wt %.

Many substances are known as palatants or tasteants and are suitable to carry out the present invention. As non-limitative examples thereof, we can cite proteins, protein hydrolysates, biological extracts, dried yeast, yeast extracts, peptones, spices and combinations thereof.

Tasteants suitable to carry out the present invention are also very various. As non-limitative examples, we can cite salts, sodium chloride, potassium chloride, glycine, alanine, monosodium glutamate, nucleotides, sodium diacetate, savory powders, pyrophosphates, warming agents, cooling agents and combinations thereof. Suitable savory powders include, but are not limited to, garlic, black pepper, onion, proteins, protein hydrolysates and combinations thereof. Suitable cooling agents include, but are not limited to, menthol, monomenthyl glutarate, N-ethyl-5-methyl-1-2-(1-methylethyl)-cyclohexanecarboxamide, N,2,3-trimethyl-2-isopropyl butanamide, N-substituted p-menthane carboxamide, acyclic carboxamides, menthyl lactate, Takasago cooling agent, 3-1-menthoxypropane-1,2-diol, menthone glycerol ketals, a tingling agent, Vanillyl alkyl ethers, Vanillyl n-butyl ether, spilanthol, capsaicin, piperine, gingerol, shoagol, cyclic acetal of vanillin, menthol glycerin ether, unsaturated amides and combinations thereof. Suitable pyrophosphates include, but are not limited to, sodium acid pyrophosphate, trisodium pyrophosphate, tetrasodium pyrophosphate, potassium acid pyrophosphate, tripotassium phosphate, tetrapotassium pyrophosphate and combinations thereof. The employment of sodium acid pyrophosphate as a palatant is further detailed in U.S. Pat. No. 5,186,964 to Gierhart et al., which is fully incorporated by reference herein. The employment of trisodium pyrophosphate as a palatant is further detailed in U.S. Pat. No. 7,186,437 to Guiller et al., which is fully incorporated by reference herein. The employment of tetrasodium pyrophosphate as a palatant is further detailed in U.S. Pat. No. 6,254,920 to Burnner, which is fully incorporated by reference herein.

Preferably and according to the invention, the palatant(s) and/or tasteant(s) of the palatability enhancing composition is (are) selected from the group consisting of phosphates, pyrophosphates, proteins, protein hydrolysates, biological extracts, dried yeast, yeast extracts, peptones and combinations thereof. Even more preferably, said pyrophosphates are selected from the group consisting of sodium acid pyrophosphate, trisodium pyrophosphate, tetrasodium pyrophosphate, potassium acid pyrophosphate, tripotassium pyrophosphate, tetrapotassium pyrophosphate and combinations thereof.

In a particular embodiment of the invention, the palatability enhancing composition further includes constituents such as dried whey, brewers yeast, fish powder, shrimp powder, shrimp meal, liver hydrolysate, tea extracts, sodium hexametaphosphate, acidulants and chelating agents. Suitable acidulants include, but are not limited to, citric acid, tartaric acid, malic acid, phosphoric acid, and combinations thereof. Suitable chelating agents include, but are not limited to, ethylenediaminetetraacetic acid, citric acid, oxalic acid and combinations thereof.

Such additional constituents can be added to the composition before or after the palatant and/or tasteant is modified. However, it is advisable to add such additional constituents after the palatant and/or tasteant is modified according to the invention.

A palatability enhancing composition according to the invention can be in a solid form. In a preferred embodiment, said composition is in a powder form, the particle size range of the powder is from about 10 mesh to about 200 mesh, and more preferably, from about 20 to about 120 mesh.

A palatability enhancing composition according to the invention is mainly intended to be applied onto the surface of a companion animal food in order to increase the palatability thereof. According to a first aspect, it consists in a ready-to-use composition which is intended to be applied onto the surface of any companion animal food, particularly a commercially available dry or semi-dry food, and preferably at dinner hours. According to a second aspect, it corresponds to an intrinsic ingredient of a commercially companion animal food.

According to the above-mentioned first aspect, the invention extends to a method for enhancing the palatability of a “basal” companion animal food comprising applying (e.g. by sprinkling, spreading, smearing, spraying . . . ) at least a palatability enhancing composition according to the invention to a surface of said “basal” companion animal food. The present invention also concerns a method for the preparation of a companion animal food, particularly cat food and dog food, comprising applying at least a palatability enhancing composition according to the invention to a surface of a “basal” companion animal food.

According to the above-mentioned second aspect, the invention extends to a companion animal food the surface of which is at least partially coated with a palatability enhancing composition according to the invention, i.e. a companion animal food the surface of which is at least partially coated with palatants and/or tasteant modified by glycerol and/or propylene glycol.

In a preferred embodiment, relative to the above-mentioned first and second aspects, said companion animal food according to the invention is a wet or semi-wet food and, even more preferably, a dry or semi-dry cat food and/or a dry or semi-dry dog food.

In one particularly preferred embodiment, which is given only as a specific example non-limitative of the invention, the companion animal food according to the invention is in the form of kibbles for cats. Its preparation can be performed as follows. A basal cat food composition is placed in a convenient container for mixing, such as a small cement mixer, tub or coating drum. A fat, such as lard, chicken fat or beef tallow, is heated to about 130° F. and sprayed onto the cat food in any convenient manner to obtain a coating of the kibble. The cat food is mixed for a few minutes after spraying the fat to improve uniformity of the coating, although a uniform coating is not crucial. After the fat is applied, it cools quickly and acts as an imperfect barrier to other compounds that are applied following the fat coating. At this point, a palatability enhancing composition according to the invention is applied in a dry powder. Alternatively, the palatability enhancing composition can be mixed with the fat and applied concurrently.

The invention also concerns a palatability enhancing composition, a companion animal food and methods for preparing thereof, characterized in combination by all or parts of the characteristics stated above or bellow. Other objectives, characteristics and advantages of the invention will become apparent on reading the following examples.

### EXAMPLES

The test data in the examples is derived from palatability trials utilizing industry standard two bowl comparison testing. A panel of cats was presented with two bowls containing a measured amount of a first cat food composition (“Diet A”) and two bowls containing a measured amount of a second cat food composition (“Diet B”). The bowls were randomly placed each day into four radio frequency monitored feeding stations at 4:45 p.m. and removed at 7:15 a.m. the next morning for a total feeding test time of 14.5 hours. Each test took place over a two day period. A radio frequency system allowed the amount of each cat food composition eaten by individual cats to be measured and recorded. Other recorded parameters included food composition first approached, food composition first tasted, animal intake by hour and by day and weight of the animal. Comparison of these parameters provides a reliable indication of relative palatability.

### Example 1

The objective of the test was to determine if commercially available dry cat food that was surface coated with a palatability enhancing composition modified according to the invention (Diet A) was more palatable than the same dry cat food surface coated with a non-modified version of the same palatability enhancing composition (Diet B). In this example, a leading dry cat palatant consisting of sodium acid pyrophosphate, dried brewers yeast, liver powder and fish powder, was tested with 6% added glycerol sprayed onto the surface of the entire palatant blend, and compared to the same palatant without glycerol coating. Both palatability enhancing compositions were applied to the commercially available dry cat food in an amount of 1.5 wt %.

The average percent consumed for Diet A was 62.73% and for Diet B was 37.27%, for a consumption ratio of 1.68:1. Diet A was significantly preferred by a ratio of 1.68:1 when offered to this panel of cats. Accordingly, this panel of cats preferred dry cat food coated with a palatability enhancing composition modified by glycerol significantly over the same dry cat food coated with a non-modified version of the same palatability enhancing composition.

### Example 2

The objective of the test was to determine if commercially available dry cat food that was surface coated with sodium acid pyrophosphate modified according to the invention (Diet A) was more palatable than the same dry cat food surface coated with non-modified sodium acid pyrophosphate (Diet B). Sodium acid pyrophosphate (granulation as received from supplier, which consisted of up to 20 mesh and finer material) was modified by a glycerol coating in an amount of 6% of the total weight of the sodium acid pyrophosphate. Both sodium acid pyrophosphate compositions were applied to the commercially available dry cat food in an amount of 0.75 wt %.

The average percent consumed for Diet A was 66.28% and for Diet B was 33.72%, for a consumption ratio of 1.97:1. Diet A was significantly preferred by a ratio of 1.97:1 when offered to this panel of cats. Accordingly, this panel of cats significantly preferred dry cat food containing sodium acid pyrophosphate modified with 6 wt % topically glycerol over the same dry cat food containing non-modified sodium acid pyrophosphate.

### Example 3

The objective of the test was to determine if commercially available dry cat food that was surface coated with a palatability enhancing composition according to the invention (Diet A) was more palatable than a market leading cat food composition (Diet B). In this example, a leading dry cat palatant, consisting of sodium acid pyrophosphate, dried brewers yeast, liver powder and fish powder, that, when applied at a rate of 2% to an industry standard dry cat kibble, typically loses >2:1 when fed versus Nestle-Purina® Cat Chow® Indoor, was treated with 6% glycerol and coated at a rate of 2% to industry standard cat kibble. When kibble coated in this manner was tested versus Nestle-Purina® Cat Chow® Indoor, parity performance was obtained.

The average percent consumed for Diet A was 45.65% and for Diet B was 54.35%, for a consumption ratio of 1:1.19. Although the results are insignificant, these results are regarded as successful because an inferior palatant and kibble was shown to achieve a parity result against the market leading Nestle-Purina® Cat Chow® Indoor product.

### Example 4

The objective of the test was to determine if commercially available dry cat food that was surface coated with a palatability enhancing composition according to the invention (Diet A) was more palatable than a market leading cat food composition (Diet B). The palatability enhancing composition comprised 80 wt % palatant, 12 wt % brewers yeast, 2 wt % fish powder and 6 wt % glycerol. In this example, a leading dry cat palatant, consisting of sodium acid pyrophosphate, dried brewers yeast, liver powder and fish powder, was diluted with yeast and seafood taste components and tested against Nestle-Purina® Cat Chow® Complete. Typically, an industry standard cat kibble coated with this palatant would not receive a parity result when tested against the market leading Nestle-Purina® Cat Chow® Complete. In this case, the palatant was coated with 6% glycerol, and diluted with dried brewers yeast, and fish powder, and a parity result was achieved vs. Nestle-Purina® Cat Chow® Complete. The palatability enhancing composition was applied to the commercially available dry cat food in an amount of 1.5 wt %.

The average percent consumed for Diet A was 41.53% and for Diet B was 58.47%, for a consumption ratio of 1:1.41. Thus, Diet B was non-significantly preferred by a ratio of 1:1.41 when offered to this panel of cats. Accordingly, this panel of cats showed a non-significant preference for the market leading dry cat food over another commercially available dry cat food that was surface coated with a palatability enhancing composition modified by glycerol. However, this result is important because the market leader is normally significantly preferred over the commercially available dry cat food employed in Diet A. The results evidence that the addition of the palatability enhancing composition modified by glycerol improves the palatability of the commercially available dry cat food employed in Diet A.

### Example 5

The objective of the test was to determine if commercially available dry cat food that was surface coated with sodium acid pyrophosphate sieved through an 80 mesh screen and modified according to the invention (Diet A) was more palatable than the same dry cat food surface coated with non-modified version of sodium acid pyrophosphate (granulation as received from supplier, which consisted of up to 20 mesh and finer material) (Diet B). The employed wetting agent was glycerol applied in an amount of 6% of the total weight of the modified sodium acid pyrophosphate. Both sodium acid pyrophosphate compositions were applied to the commercially available dry cat food in an amount of 0.75 wt %.

The average percent consumed for Diet A was 63.72% and for Diet B was 36.28%, for a consumption ratio of 1.76:1. Thus, Diet A was significantly preferred by a ratio of 1.76:1 when offered to this panel of cats. Accordingly, this panel of cats preferred dry cat food coated with sodium acid pyrophosphate sieved through an 80 mesh screen and modified by glycerol significantly over the same dry cat food coated with a non-modified version of the same 80 mesh sodium acid pyrophosphate.

### Example 6

The objective of the test was to determine if commercially available dry cat food that was surface coated with sodium acid pyrophosphate sieved through an 120 mesh screen and modified according to the invention (Diet A) was more palatable than the same dry cat food surface coated with non-modified version of sodium acid pyrophosphate (granulation as received from supplier, which consisted of up to 20 mesh and finer material) (Diet B). The employed wetting agent was glycerol applied in an amount of 6% of the total weight of the modified sodium acid pyrophosphate. Both sodium acid pyrophosphate compositions were applied to the commercially available dry cat food in an amount of 0.75 wt %.

The average percent consumed for Diet A was 55.93% and for Diet B was 44.07%, for a consumption ratio of 1.27:1. Thus, Diet A was statistically preferred by a ratio of 1.27.1 when offered to this panel of cats. Accordingly, this panel of cats preferred dry cat food coated with sodium acid pyrophosphate sieved through an 120 mesh screen and modified by glycerol slightly over the same dry cat food coated with a non-modified version of 120 mesh sodium acid pyrophosphate.

### Example 7

The objective of the test was to determine if commercially available dry cat food that was surface coated with a palatability enhancing composition including sodium acid pyrophosphate first modified according to the invention and then mixed with other non-modified constituents (Diet A) was more palatable than the same dry cat food that was surface coated with a palatability enhancing composition including sodium acid pyrophosphate mixed with other constituents, and the mixture then modified by a wetting agent (Diet B). The palatability enhancing composition employed in Diet A comprised 50 wt % sodium acid pyrophosphate modified with 6 wt % glycerol that is blended with 15 wt % liver and 25 wt % yeast. The palatability enhancing composition employed in Diet B comprised a mixture of 56.4 wt % sodium acid pyrophosphate, 25 wt % yeast and 15 wt % liver, and that mixture was modified by 3.6 wt % glycerol. Both palatability enhancing compositions were applied to the commercially available dry cat food in an amount of 1.5%. In both cases, the formula weights were identical, the only variable being coating sodium acid pyrophosphate itself or coating the entire palatant blend, containing sodium acid pyrophosphate.

The average percent consumed for Diet A was 71.93% and for Diet B was 28.07%, for a consumption ratio of 2.56:1. Thus, Diet A was significantly preferred by a ratio of 2.56:1 when offered to this panel of cats. Accordingly, this panel of cats preferred dry cat food surface coated with a palatability enhancing composition including sodium acid pyrophosphate first modified by a glycerol coating and then mixed with other non-modified constituents significantly over the same dry cat food surface coated with a palatability enhancing composition that includes sodium acid pyrophosphate mixed with other constituents, and the mixture then modified by a glycerol coating.

### Example 8

The objective of the test was to determine if commercially available dry cat food that was surface coated with a palatability enhancing composition according to the invention (Diet A) was more palatable than a market leading cat food composition (Diet B). The palatability enhancing composition comprised 82 wt % palatant, 12 wt % brewers yeast, and 6 wt % glycerol. In this example, a leading dry cat palatant was diluted with added yeast, wetted with 6% glycerol, and tested against Nestle-Purina® Cat Chow® Complete. Typically this palatant would not receive a parity result when tested against the market leading Nestle-Purina® Cat Chow® Complete. In this case, the palatant was wetted with 6% glycerol, and a parity result was achieved vs. Nestle-Purina® Cat Chow® Complete. The palatability enhancing composition was applied to the commercially available dry cat food in an amount of 1.5 wt %.

The average percent consumed for Diet A was 45.84% and for Diet B was 54.16%, for a consumption ratio of 1:1.18. Thus, Diet B was non-significantly preferred by a ratio of 1:1.18 when offered to this panel of cats. Accordingly, this panel of cats showed a non-significant preference for the market leading dry cat food over another commercially available dry cat food that was surface coated with a palatability enhancing composition modified by glycerol. However, this result is important because the market leader is normally significantly preferred over the commercially available dry cat food employed in Diet A. The results evidence that the addition of the palatability enhancing composition modified by glycerol improves the palatability of the commercially available dry cat food employed in Diet A.

What is claimed is:

1. A palatability enhancing composition comprising at least one palatant and/or at least one tasteant modified by glycerol and/or propylene glycol.

2. The composition of claim 1, wherein the wetting agent is glycerol.

3. The composition of claim 2, wherein the composition comprises up to about 15% by weight glycerol.

4. The composition of claim 2, wherein the composition comprises from about 0.1% to about 6% by weight glycerol.

5. The composition of claim 1, wherein at least a part of the surface of said palatant and/or tasteant, in a solid form, is coated by a thin film of the glycerol.

6. The composition of claim 1, wherein the palatant is selected from the group consisting of phosphates, pyrophosphates, proteins, protein hydrolysates, biological extracts, dried yeast, yeast extracts, peptones and combinations thereof.

7. The composition of claim 6, wherein the pyrophosphates are selected from the group consisting of sodium acid pyrophosphate, trisodium pyrophosphate, tetrasodium pyrophosphate, potassium acid pyrophosphate, tripotassium pyrophosphate, tetrapotassium pyrophosphate and combinations thereof.

8. The composition of claim 1, wherein the composition is intended to be applied to a surface of a companion animal food.

9. The composition of claim 1, wherein the composition is intended to be applied to a surface of a dry or semi-dry cat food and/or a surface of a dry or semi-dry dog food.

10. A method for the preparation of a companion animal food comprising:
applying at least a palatability enhancing composition according to claim 1 to the surface of a basal companion animal food.

11. The method of claim 10, wherein the companion animal food composition is a dry or semi-dry cat food or a dry or semi-dry dog food.
